(19) United States
(12) Patent Application Publication
(10) Pub. No.: US 2016/0381191 A1
(43) Pub. Date: Dec. 29, 2016

(54) DYNAMIC MANAGEMENT OF INACTIVITY TIMER DURING INTER-PROCESSOR COMMUNICATION

(71) Applicant: Intel IP Corporation, Santa Clara, CA (US)

(72) Inventors: Jean Marque, Plaisance du Touch (FR); Eric Perraud, Plaisance du Touch (FR)

(73) Assignee: INTEL IP CORPORATION, Santa Clara, CA (US)

(21) Appl. No.: 14/751,977

(22) Filed: Jun. 26, 2015

(51) Int. Cl. H04L 29/06; H04L 12/911; H04L 12/26; G06F 9/54

(52) U.S. Cl. CPC H04L 69/28; G06F 9/54; H04L 47/70; H04L 43/0876

(57) ABSTRACT

An apparatus is described herein. The apparatus includes a first processor and a second processor. The first processor and the second processor communicate via an inter-processor communication link. The apparatus also includes a inactivity timer control module The inactivity timer control module is to manage a state of the communications link based on data traffic characteristics.

### TECHNICAL FIELD

The present techniques relate generally to inter-processor communication. More specifically, the present techniques relate to the management of inactivity time periods during inter-processor communication.

### BACKGROUND ART

Computing devices typically include multiple processors that communicate with one another via inter-processor communication (IPC). The multiple processors can be any combination of application processors, baseband processors, media processors, or connectivity processors. The communication between processors may occur according to various protocols, such as a Universal Serial Bus (USB), Inter-Integrated Circuit (I2C), Serial Peripheral Interface (SPI), Universal Asynchronous Receiver/Transmitter (UART), Controller Area Network (CAN), or Direct Memory Access (DMA) protocol.

### BRIEF DESCRIPTION OF THE DRAWINGS

FIG. 1 is a block diagram of a computing device 100 with dynamic management of an activity timer;

FIG. 2 is an illustration of a system 200 with dynamic management of an activity timer;

FIG. 3A is a process flow diagram of a method 300A for dynamic management of an inactivity timer;

FIG. 3B is a process flow diagram of a method for dynamic management of an inactivity timer with a paused connection;

FIG. 3C is a process flow diagram of a method for implementing an inactivity module; and

FIG. 4 is a block diagram showing tangible, non-transitory computer-readable media 400 that stores code for the management of inactivity time periods during inter-processor communication.

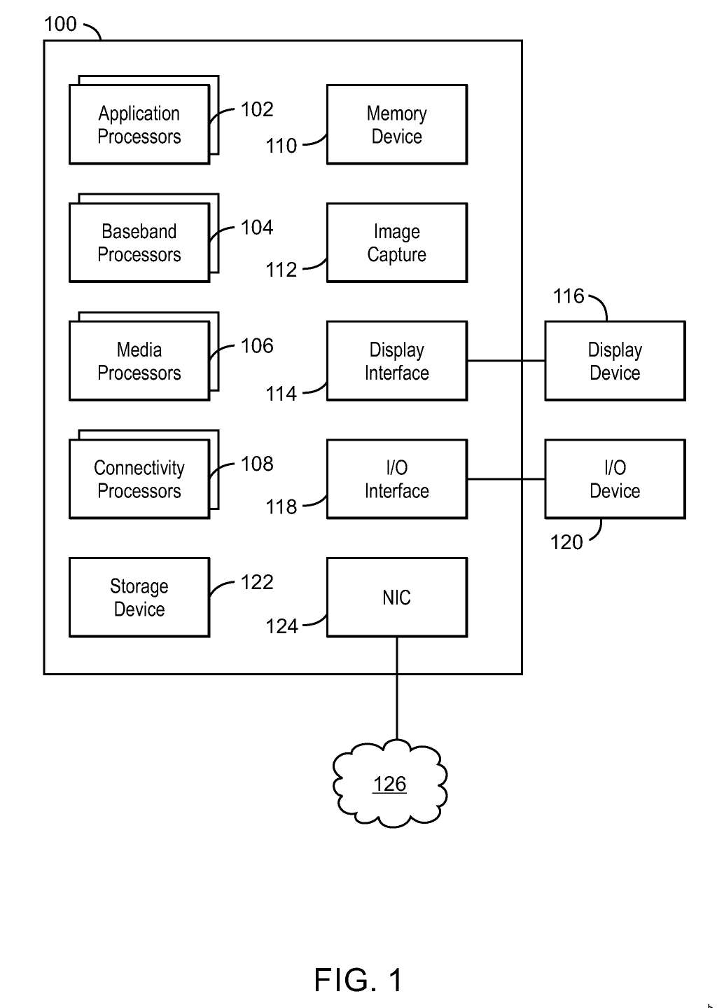

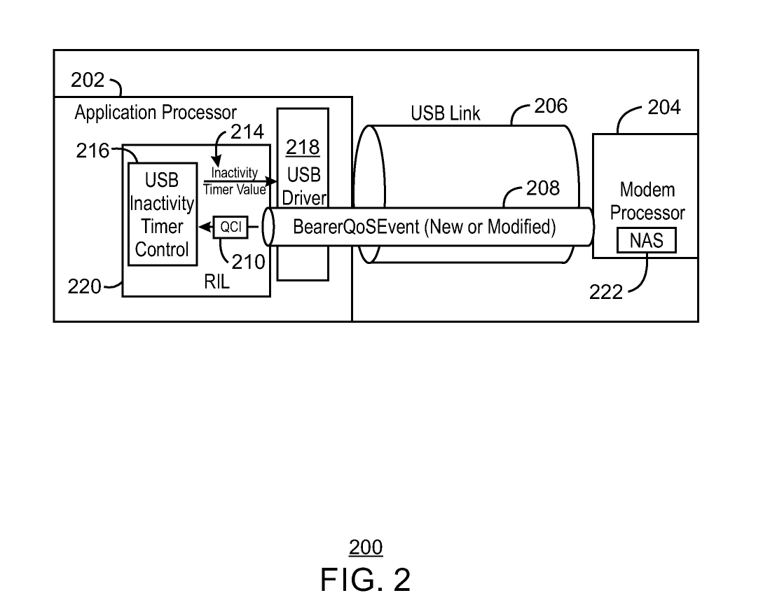

The same numbers are used throughout the disclosure and the figures to reference like components and features. Numbers in the 100 series refer to features originally found in FIG. 1; numbers in the 200 series refer to features originally found in FIG. 2; and so on.

### Description of the Embodiments

Computing devices, such as smartphones and tablets can use inter-processor communication (IPC) between various processors. The communications link between one or more processors can employ an inactivity timer to manage the use of the link and the ability of the platform to enter a sleep state based on the link. For example, on smartphones and tablets with USB-based IPC between a modem processor and an application processor, the USB link can prevent the platform from entering a sleep mode when periodic short data transfers like ping, Voice over Long Term Evolution (LTE), Video over LTE, or periodic background application synchronization over the cellular radio occurs. For these exemplary use cases, the active duty cycle of the USB is small. The small active duty cycle prevents the link, application process, and modem processor from entering sleep mode, no optimization of power use, and is equivalent to a continuous data transfer over the air.

Embodiments described herein enable dynamic management of an inactivity timer during inter-processor communication. In embodiments, the management of the inactivity timer during IPC is according to Quality of Service requirements of each application or process that is driving the inter-processor communication.

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the invention described herein.

FIG. 1 is a block diagram of a computing device 100 with dynamic management of an activity timer. The computing device 100 may be, for example, a smartphone, laptop, ultrabook, tablet, or mobile phone, among others. The computing device 100 may include an application processor 102, baseband processor 104, media processors 106, and a connectivity processor 108. The application processors 102 may be used to execute an operating system and various applications software. In embodiments, the application processors 102 may also perform processing related to the user interfaces and data networking functions. The basebands processors 104 are typically tasked only with the execution of processing related to the actual communication over the radio, transmitters, receivers, and transceivers of the computing device. Accordingly a modem processor may be a baseband processor 104.

A media processor 106 may be configured to interface to a high speed input/output subsystem that is configured to render or manipulate graphics images, graphics frames, videos, or the like, to be displayed to a user of the computing device 100. The connectivity processor 108 may enable general cellular network connectivity as provided by wireless carriers, such as that provided via GSM (global system for mobile communications) or variations or derivatives, CDMA (code division multiple access) or variations or derivatives, TDM (time division multiplexing) or variations or derivatives, or other cellular service standards. Wireless connectivity (or wireless interface) that is not cellular may also be enabled, and can include personal area networks (such as Bluetooth, Near Field, etc.), local area networks (such as Wi-Fi), and/or wide area networks (such as WiMax), or other wireless communication. The processors described herein may be single core processors, multi-core processors, a computing cluster, or any number of other configurations. Furthermore, the computing device 100 may include more than one of each processor, and also other processors that are not described herein. While the application processors 102, baseband processors, media processors 106, and connectivity processor 108 are described as performing distinct functions, each processor can perform any of the functions described herein, and also functions not described herein. The description of the processors is for ease of description and should not be viewed as limiting.

In embodiments, an application processor 102 and a modem processor 104 communicate via a USB-based IPC. With USB-based IPCs, if the USB inactivity timeout value is low, the USB link will often enter sleep mode. In this manner, the modem and the application processor can enter in low power mode during the USB suspend mode, and the power consumption is optimized. However, since the USB is not a low latency IPC, it consumes several milliseconds (˜50 ms) to wake up and exit the sleep mode. As a result, each time the USB has to wake up, the data path incurs a 50 ms penalty for both uplink and downlink data directions. Many real-time applications, such as like gaming, Video over LTE, Voice over LTE, cannot operate as expected with waiting 50 ms to exit a sleep mode that occurs too frequently. On the other hand, if the inactivity timeout value is high, the USB link, application processor, and modem process with rarely enter a sleep mode. This quickly consumes battery life, however, performance of real-time applications meets the Quality of Service (QoS) and the latency does not have a great effect on the user experience. As used herein, a sleep mode refers to a powered down or low power state wherein a processor consumes little or no power. Further, in a sleep mode, the processor may have some functionality. However, functions may be executed at a slower rate compared to when the processor is fully powered. Additionally, a sleep mode may include powering down particular sections or cores of the processor.

The computing device 100 may also include a memory device 110 that stores instructions that are executable by the other processors. The memory device 110 can include random access memory (RAM), read only memory (ROM), flash memory, or any other suitable memory systems. For example, the memory device 110 may include dynamic random access memory (DRAM). The computing device 100 includes an image capture mechanism 112. In some embodiments, the image capture mechanism 112 is a camera, stereoscopic camera, scanner, infrared sensor, or the like.

The computing device 100 may also include a display interface 114 configured to connect the computing device 100 to a display device 116. The display device 116 may include a display screen that is a built-in component of the computing device 100. The display device 116 may also include a computer monitor, television, or projector, among others, that is externally connected to the computing device 100. Further, the computing device 100 may also include an input/output (I/O) device interface 118 configured to connect the computing device 100 to one or more I/O devices 120. The I/O devices 120 may include, for example, a keyboard and a pointing device, wherein the pointing device may include a touchpad or a touchscreen, among others. The I/O devices 120 may be built-in components of the computing device 100, or may be devices that are externally connected to the computing device 100.

The computing device 100 also includes a storage device 122. The storage device 122 is a physical memory such as a hard drive, an optical drive, a thumbdrive, an array of drives, or any combinations thereof. The storage device 122 may also include remote storage drives. The computing device 100 may also include a network interface controller (NIC) 124 may be configured to connect the computing device 100 to a network 126. The network 126 may be a wide area network (WAN), local area network (LAN), or the Internet, among others.

The block diagram of FIG. 1 is not intended to indicate that the computing device 100 is to include all of the components shown in FIG. 1. Further, the computing device 100 may include any number of additional components not shown in FIG. 1, depending on the details of the specific implementation.

As described above, there is a tradeoff between power consumption and performance (latency) with respect to an inactivity timeout. If USB inactivity timeout is low, the power consumption is improved because it can quickly enter suspend mode and allow both the application and modem processors to optimize the sleep periods. However, the latency associated with “waking up” the USB link, application processor, and modem processor degrades performance of real-time applications. If the inactivity timeout is high, the platform never sleeps and the latency is better because the USB transfers the data without any delay. In the example of USB inactivity timeout, the value is typically static and set to 500 ms by default on a Linux kernel. This timeout value is not the best value for all cases. Specifically, if the data traffic has no real time or latency constraints, for example, internet browsing, email inbox checking etc., the timeout value can be reduced. However, if the data traffic does include real time and latency constraints, such as voice over LTE calls, real time gaming, etc., then timeout value can be increased.

Consider a simple ping sent every second with a 75 ms round trip time. If the USB inactivity timeout value is set to 1s, the platform will never sleep, the power consumption is equivalent to a continuous data transfer over LTE, around 950 mW, but the ping round trip time is very good at approximately 75 ms. If the USB inactivity timeout value is set to 50 ms, the platform sleeps most of the time, the power consumption is good, around 250 mW, but the ping round trip time is degraded at approximately 175 ms.

In embodiments, a-priori knowledge of the Quality of Service requirements of the data traffic can be used to dynamically change the inactivity timer, so that the user experience is not degraded and the power consumption is optimized. The QoS requirements can be indicated using any QoS parameter that includes information on performance characteristics associated with the data packets transmitted by each application. In embodiments, the QoS parameter is a Quality of Service (QoS) Class Identifier (QCI). In a third generation (3G) application, the QoS parameter may be class traffic as a parameter of the packet data protocol (PDP) context in 3G.

In the cellular world (HSPA/LTE), the data traffic Quality of Service is known by the modem through the QCI. Additionally, in embodiments, a fourth generation (4G) application may use the QCI to define a particular QoS. This QCI is defined as an integer from 1 to 9, where each integer indicates nine different QoS performance characteristics of each internet protocol (IP) packet. QCI values are standardized to reference specific QoS characteristics, and each QCI contains standardized performance characteristics (values), such as resource type, priority (1-9), Packet Delay Budget (allowed packet delay shown in values ranging from 50 ms to 300 ms). These values are illustrated in Table 1.

TABLE 1

| | | | | Packet | |
|---|---|---|---|---|---|
| | Re- | | Packet | error | |
| | source | | delay | loss | |
| QCI | Type | Priority | budget | rate | Example Services |
| 1 | GBR | 2 | 100 ms | 10⁻² | Conversational voice |
| 2 | | 4 | 150 ms | 10⁻³ | Conversational video |
| | | | | | (live streaming) |
| 3 | | 3 | 50 ms | 10⁻³ | Real time gaming |
| 4 | | 5 | 300 ms | 10⁻⁵ | Non-conversational video |
| | | | | | (buffered streaming) |
| 5 | Non- | 1 | 100 ms | 10⁻³ | IMS signaling |
| 6 | GRB | 6 | 300 ms | 10⁻⁶ | Video (buffered streaming) |
| | | | | | TCP-based (e.g., www, |
| | | | | | email, chat, ftp, p2p file |
| | | | | | sharing, progressive video, |
| | | | | | etc.) |
| 7 | | 7 | 100 ms | 10⁻⁶ | Voice, Video (live |
| | | | | | streaming), Interactive |
| | | | | | gaming |
| 8 | | 8 | 300 ms | 10⁻³ | Video (buffered streaming), |
| 9 | | 9 | | 10⁻⁶ | TCP-based (e.g., www, |
| | | | | | email, chat, ftp, p2p file |
| | | | | | sharing, progressive |
| | | | | | video, etc.) |

The QCI values are further defined by resource type. In particular, the resource type may be reported by the modem as guaranteed bit rate (GBR) bearers or non-guaranteed bit rate (NBGR) bearers. Generally, a bearer is a set of network configurations, a pathway, or a pipeline that enables the transmission of network traffic. In embodiments, if the modem reports GBR (Guaranteed Bit Rate) bearers, it means that the traffic of data which is handled by the cellular modem carries real-time data. The latency shall be analyzed to determine the USB Inactivity Timeout value. Since the end-to-end delay is critical, the USB Inactivity Timer shall be high (higher than the period of 2 consecutive data burst) to avoid the USB link to go in suspend mode. If the modem reports NGBR (Non-Guaranteed Bit Rate) bearers, it means that the traffic of data which is handled by the cellular modem does not carry any real-time data. In this case, the latency does not matter. The power shall be privileged, such that the USB Inactivity Timer is low so that the USB link can enter low power mode as fast as possible and allow the application processor to go in sleep mode according to the use or non-use of the link.

The priority value listed in Table 1 defines a priority for each QCI value. The value of priority ranges from one to nine, with one being the highest value. In embodiments, the priority level is used to differentiate between the various bearers. Further, the packet budget delay defines an upper limit on the delay experienced by a packet, associated with each bearer. Similarly, the packet error loss rate defines the upper limit on the rate of non-congestion related packet losses. Finally, the Example Services in FIG. 1 provide exemplary applications and functionality associated with each QCI value.

There are two kinds of applications and services that can impact the inactivity timeout value setting. Real time applications include real time gaming, conversational voice or video. Non real time applications include TCP-based transfers, etc. For real-time applications, the performance is critical. Another characteristics of such an application is that the traffic is quite bursty and periodic (20 or 40 ms typically for a VoLTE, 160 ms during silence periods). The USB link should ideally not go to sleep between 2 successive traffic bursts so that the latency of such an application is not delayed by the USB wake-up time. For non-real time applications, the battery life can be optimized. With non-real time applications, the USB link can be placed in sleep mode as often as possible. The user experience will not be degraded in this case, since the application does not have real time constraint. For example, for internet browsing, the user experience will not be degraded if the data path round trip time has a 50 ms penalty. The 50 ms penalty is the 50 ms latency associated with powering up the link to complete data transfer.

In embodiments, the QoS parameter, such as QCI values or class traffic as a parameter of the PDP context in 3G applications, are retrieved from the modem when some applications (which generate traffic over the USB bus) are running on the application processor. In fourth generation (4G) applications, the QOS parameter may be a QCI value. The QoS parameters provide a-priori knowledge of the Quality of Service requirements of the application driving the USB traffic. Next, an optimized value for the USB inactivity timeout value is applied according to the aggregated quality of service requirements, as discovered according to the QoS parameters. Additionally, with 3G technology, the QoS parameters can be the traffic class parameters of the created PDP contexts. If the traffic class indicates a voice or streaming class, it means that real time traffic is carried by the USB. The traffic class can also indicate the interactive or best effort class, meaning that non-real time traffic is carried by the USB.

FIG. 2 is an illustration of a system 200 with dynamic management of an activity timer. In FIG. 2, an application processor 202 is coupled with a modem processor 204 via a USB link 206. The modem processor may include or store QCI values associated with each type of traffic is routes to the application processor. The USB link illustrates a bearer QoS event 208. In embodiments, the modem processor may create a bearer for each type of traffic routed to the application processor. Accordingly, although a single bearer 208 is illustrated, the USB link may include any number of bearers, as traffic between the modem processor 204 and the application processor requires. Bearers may also be created and terminated on the fly, as the traffic between the modem processor 204 and application processor 202 changes.

The application processor 202 can retrieve the QCI 210 values of the current running applications from the modem. The application processor will compute the best USB inactivity timeout value 212 via the USB inactivity timer control module 216 and will modify it on the fly. As used herein, on the fly means as necessary, automatically, or in real time. Each time an application sending or receiving data through the modem starts or stops a data transfer, the cellular network maps this new traffic either to an existing bearer 208 (whose attributes—including QCI—may be modified) or to a new bearer, the modem informs the application processor. The application processor will update the USB inactivity timeout accordingly.

The USB driver 218 is the software control module of the USB. In embodiments, the USB driver 218 sets configuration parameters such as the Inactivity Timeout value. In embodiments, the USB inactivity timer control module 216 can typically be part of the Radio Interface Layer (RIL) module 220. The RIL module 220 intercepts events about bearer creation or modification as received from the modem Non-Access Stratum (NAS) layer 222 and catches the QCI value associated with the data traffic. The RIL module then analyzes all active QCI values and updates the inactivity timeout value 218 accordingly. Although the present techniques are described as being performed at the RIL module 220, the present techniques can be implemented by any hardware, software, or any combination thereof based on capture of the QoS parameters to regulate the USB inactivity time value. In embodiments, the inactivity timeout value is calculated by the IPC master processor. A processor may be designated the IPC master processor when it is the processor that is responsible for various tasks and functions executed at a secondary, or slave, processor. The IPC master processor can be the application processor or the modem processor, for example.

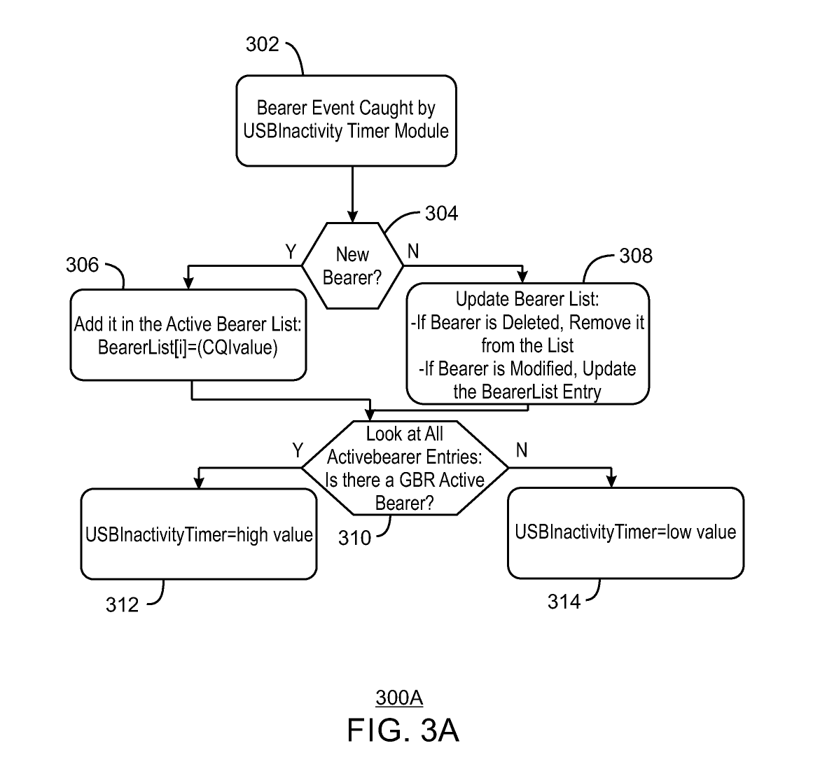

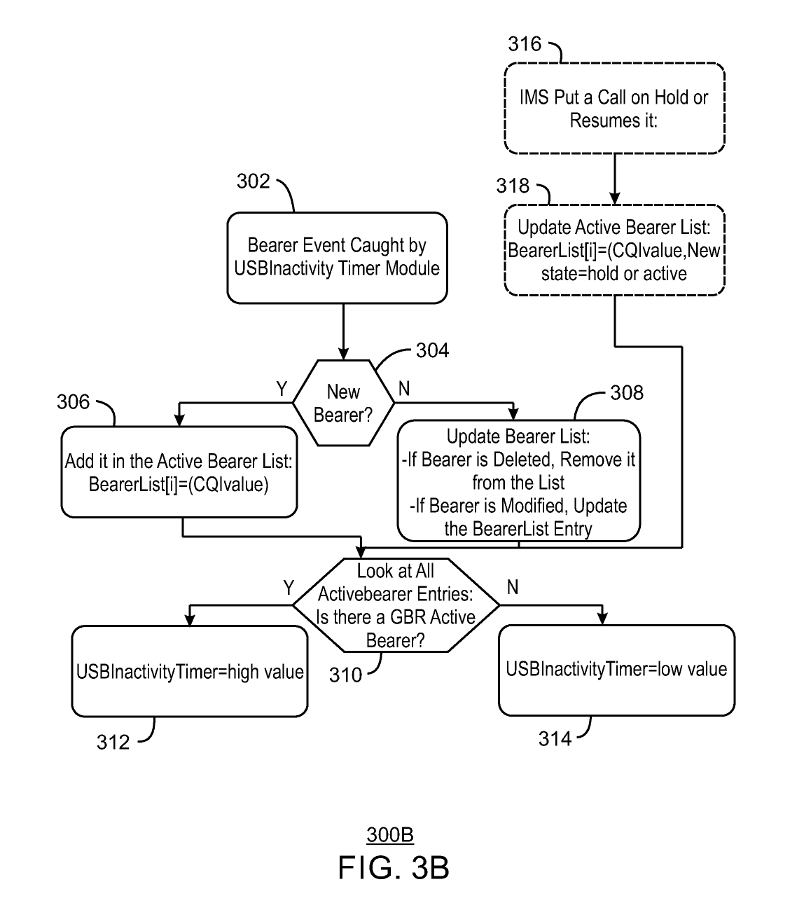

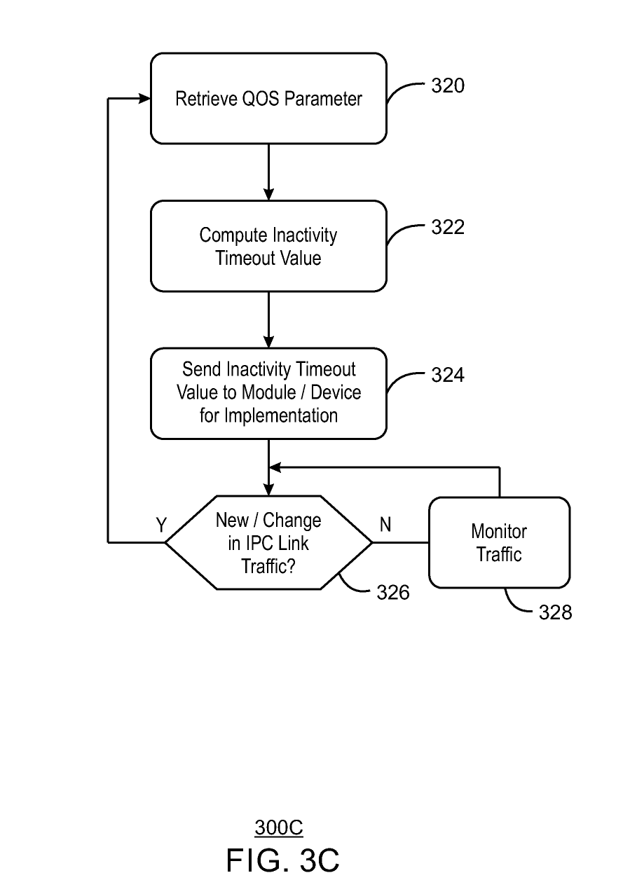

FIG. 3A is a process flow diagram of a method 300A for dynamic management of an inactivity timer. The left branch of the final decision is invoked when the USB traffic carries latency-sensitive traffic; the right branch is invoked when the USB traffic does not carry any real-time data. At block 302, a bearer event is caught by the USB inactivity timer module. At block 304, it is determined if a new bearer is required. If a new bearer is required, process flow continues to block 306. If a new bearer is not required, process flow continues to block 308. At block 306, the new bearer is created and added to the active bearer list, and process flow continues to block 310. At block 308, the bearer list is updated. If a bearer is deleted, it is removed from the bearer list. If a bearer is modified, the bearer list entry for that particular bearer is updated.

At block 310, it is determined if there is an active GBR bearer. If there is an active GBR bearer, process flow continues to block 312. If there is not an active GBR bearer, process flow continues to block 314. At block 312, the USB inactivity timeout value is calculated, resulting in a high timeout value. The high timeout value is relative to an average static timeout value that is typically set by an operating system. The high timeout value results in avoiding a suspend or sleep mode at the USB link. At block 314, the USB inactivity timeout value is calculated, resulting in a low timeout value. Similarly, the low timeout value is relative to an average static timeout value that is typically set by an operating system. The low timeout value results the USB link entering a low power, sleep or suspend mode as fast as possible.

An alternate implementation can be implemented in parallel or with using QCI values to set the USB inactivity time value. Instead of using only QCI values or traffic class information from the modem, the USB driver may also analyze the type of traffic by intercepting the Type of Service (TOS) bits of the internet protocol (IP) traffic. These optional bits in the IP header can help to determine the classes of IP traffic and their quality of service requirements as listed in Table 2.

TABLE 2

TOS = 1000: Minimize delay
TOS = 0100: Maximize throughput
TOS = 0010: Maximize reliability
TOS = 0001: Minimize the monetary cost

If TOS=1000 for one IP connection flowing across the USB, the USB driver should set at a high value, similar to block 312 of FIG. 3A. In this manner, the latency is not degraded by the USB wake-up time. If TOS is not “0100” for all IP connections flowing the USB, it would mean that the traffic is not a real-time traffic and the USB wake-up activity timer can be set to a low value.

FIG. 3B is a process flow diagram of a method for dynamic management of an inactivity timer with a paused connection. In embodiments, preset techniques can be extended to the case where a real time connection is established, but is paused. As used herein, a pause refers to a temporary halt to a data connection or transmission. For example, a Voice over LTE connection can be put on hold by the user. The bearer attributes are unchanged, however, the VoLTE bearer carries only KeepAlive RTCP reports, which do not have any real-time requirements. The only requirement is that these reports reach the peer device.

Accordingly the process flow diagram and the embodiment can be modified as follows. A state is associated with each bearer and considered in steps 306, 308 and 318 of the flow. In embodiments, the state is one of active, on-hold, or disabled. Active refers to a bearer that is currently being used and transmitting data. On-hold refers to a bearer that is paused and expected to resume data transmission. Additionally, disabled refers to a bearer that has been paused indefinitely. As an example, at block 316, an Internet Multimedia Subsystem (IMS) places a call on hold, or resumes a call. At block 318, the state of the IMS bearers is updated. Process flow then continues to block 310 by considering the updated list of active bearers. The left branch of the final decision is invoked when the USB traffic carries latency-sensitive traffic. As another example, at block 306, a new bearer is present and the new bearer is created and added to the active bearer list with its QoS associated parameter and state set to active. Process flow then continues to block 310.

FIG. 3C is a process flow diagram of a method 300C for implementing an inactivity module. In embodiments, the USB inactivity timer control module is a management module that is to determine a timer value that is used to determine when the IPC can be powered down. At block 320, a QoS parameter is retrieved. At block 322 an inactivity timeout value is computed based on the current QoS parameters of all the traffic on the IPC link. Each time an application sending or receiving data through the modem starts or stops, the network maps this new traffic either to an existing bearer (whose attributes—QCI—may be modified) or to a new bearer. The modem processor can then inform the USB inactivity timer control module of the new bearer. Accordingly, at block 320, the inactivity timeout module may receive the QoS parameter from a processor, such as the modem processor. In response to the new data traffic, the inactivity timer then updates the inactivity value accordingly.

At block 324, the inactivity timeout value is sent to a module or a device for implementation. In embodiments, the new timeout value is then sent to a USB driver and is used to regulate the timeout of the IPC link. In embodiments, the timeout value is a value that when it is exceeded, the IPC link may be powered down or otherwise placed in a sleep state. At block 326, it is determined if there is new IPC link traffic or a change in IPC link traffic. If there is new IPC link traffic or a change in IPC link traffic, process flow returns to block 320 where another QoS parameter is retrieved. If there is no new IPC link traffic or no change in IPC link traffic, process flow continues to block 328, there the traffic is monitored by the inactivity module.

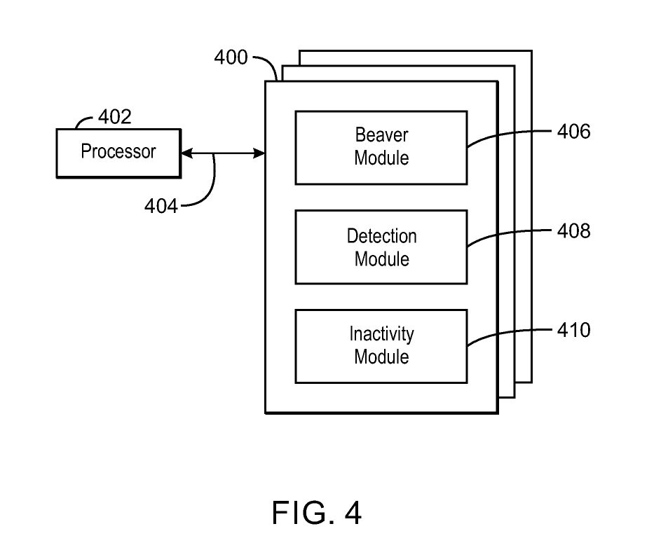

FIG. 4 is a block diagram showing tangible, non-transitory computer-readable media 400 that stores code for the management of inactivity time periods during inter-processor communication. The tangible, non-transitory computer-readable media 400 may be accessed by a processor 402 over a computer bus 404. Furthermore, the tangible, non-transitory computer-readable medium 400 may include code configured to direct the processor 402 to perform the methods described herein.

The various software components discussed herein may be stored on one or more tangible, non-transitory computer-readable media 400, as indicated in FIG. 4. For example, a bearer module 406 may be configured to determine if a new bearer is required to accommodate the IPC. A detection module 408 may determine if the is a GBR bearer among the active bearers. At block 410, an inactivity module is to calculate a new inactivity timeout value. In embodiments, the inactivity timeout value is calculated on the fly. In response to the knowledge of the end-user QoS requirements regarding the USB traffic and the state of the connection, the USB inactivity timeout value will be optimized without any impact on the user experience, and the battery life will be optimized. The tradeoff power/user's experience is optimized.

The block diagram of FIG. 4 is not intended to indicate that the tangible, non-transitory computer-readable media 400 is to include all of the components shown in FIG. 4. Further, the tangible, non-transitory computer-readable media 800A may include any number of additional components not shown in FIG. 4, depending on the details of the specific implementation.

While the present techniques have been described with respect to a limited number of embodiments, those skilled in the art will appreciate numerous modifications and variations therefrom. It is intended that the appended claims cover all such modifications and variations as fall within the true spirit and scope of this present techniques.

### EXAMPLE 1

An apparatus for management of inactivity timer is described herein. The apparatus comprises a first processor, a second processor, and an inactivity timer control module. The first processor and the second processor are communicatively coupled via an inter-processor communication (IPC) link. The inactivity timer control module is to manage a state of the IPC communication link via an inactivity timeout value based on a Quality of Service parameter.

In examples, the Quality of Service parameter may be a tabulated value that may be to reflect a traffic class of data. The Quality of Service parameter may also be a Quality of Service Class Identifier (QCI) for data traffic transmitted using fourth generation (4G) data transmission. Further, the Quality of Service parameter may be a traffic class of a packet data protocol (PDP) context for data traffic flowing over third generation (3G) data transmission. The Quality of Service parameter can also may be determined by analyzing a type of traffic by intercepting Type of Service (TOS) bits of data traffic. In examples, the Quality of Service parameter may be a combination of the Traffic Class of the Packet Data Protocol (PDP) context for the traffic flowing over 3G, or Quality of Service Class Identifier (QCI) for the traffic flowing over 4G, and the Type of Service bits for internet protocol (IP) traffic.

A state of the communications link may be a power state. In examples, the power state may be sleep state or active state. The state may also be powered-down state or powered-up state. Further, the state may be based on an inactivity timeout value to be calculated using QoS parameters from all traffic on the IPC link. The inactivity timeout value is used by a driver to manage the IPC link. The first processor may be a modem processor, and the second processor may be an application processor. In examples, a QCI or Traffic class value table may be stored at the first processor.

### EXAMPLE 2

A method for dynamic management of an inactivity timer is described herein. The method comprises adding a bearer in response to a bearer event (208) and detecting a type of bearer and a corresponding Quality of Service parameter. The method also comprises calculating an inactivity timeout value based on the type of bearer and a corresponding Quality of Service parameter.

In examples, the Quality of Service parameter may be a QCI or Traffic Class value. The Quality of Service parameter may also be determined by analyzing a type of traffic by intercepting a Type of Service (TOS) bits of an IP traffic. Adding a bearer may comprise generating a new bearer entry or updating an existing bearer entry. Additionally, the inactivity timeout value may be calculated as the highest timeout value associated with each active bearer. In examples, the bearer may transmit data between an application processor and a remote device through a modem processor. The inactivity timeout value may be calculated by an IPC master processor. The Quality of Service parameter may be stored at the modem processor. Further, the inactivity timeout value may be updated on the fly, according to any change of the Quality of service requirements reflected in the QCI or Traffic Class of the PDP context. Additionally, the inactivity timeout value may be updated on the fly, in response to a bearer being put on hold or resumed.

### EXAMPLE 3

A system for management of inactivity timer is described herein. The system comprises an inter-processor communication (IPC) link, a memory, an inactivity timer control module, a processor, and another processor. The memory is to store instructions and that is communicatively coupled with the IPC link. The processor is communicatively coupled to the memory, wherein when the processor is to execute the instructions, the processor is to communicate with an another processor via the IPC link, wherein the inactivity timer control module is to manage a state of the IPC link based on a Quality of Service parameter.

In examples, the Quality of Service parameter may be a tabulated value that may be to reflect a traffic class of data. The Quality of Service parameter may also be a Quality of Service Class Identifier (QCI) for data traffic transmitted using 4G. Further, the Quality of Service parameter may be a traffic class of a packet data protocol (PDP) context for data traffic flowing over 3G. The Quality of Service parameter may be determined by analyzing a type of traffic by intercepting Type of Service (TOS) bits of IP traffic. In examples, the Quality of Service parameter may be a combination of a traffic class of the packet data protocol (PDP) context for the traffic flowing over 3G, or Quality of Service Class Identifier (QCI) for the traffic flowing over 4G, and the Type of Service bits for IP traffic.

Moreover, in examples, a state of the IPC link may be a power state. The power state may be sleep state or active state. Additionally, the state may be powered-down state or powered-up state. In examples, the IPC link may be a USB link. The inactivity timer control module may be integrated into the processor or the another processor. Further, the processor may be a modem processor, and the another processor may be an application processor. A QCI or Traffic class value table may be stored at the processor.

### EXAMPLE 4

An apparatus for management of inactivity timer is described herein. The apparatus comprises a first processor, a second processor, and a means to manage a timeout value of the communications link. The first processor and the second processor communicate via an inter-processor communication (IPC) link. The means to manage a timeout value of the communications link is based on a Quality of Service parameter, wherein the Quality of Service parameter is managed by the first processor.

In examples, the Quality of Service parameter may be a tabulated value reflecting a traffic class of data. The Quality of Service parameter may be a Quality of Service Class Identifier (QCI) for data traffic transmitted using 4G. The Quality of Service parameter may also be a traffic class of a packet data protocol (PDP) context for data traffic flowing over 3G. Additionally, the Quality of Service parameter may be determined by analyzing a type of traffic by intercepting Type of Service (TOS) bits of data traffic. Moreover, the Quality of Service parameter may be a combination of the Traffic Class of the Packet Data Protocol (PDP) context for the traffic flowing over 3G, or Quality of Service Class Identifier (QCI) for the traffic flowing over 4G, and the Type of Service bits for IP traffic.

In examples, a state of the first processor, the second processor, and the communications link may be changed based on the timeout value. The power state may be sleep state or active state. The state may also be powered-down state or powered-up state. In examples, the link may be a USB link. Further, the means to manage a timeout value of the communications link may be integrated into the second processor. The first processor may be a modem processor, and the second processor may be an application processor. Additionally, a QCI or Traffic class value table may be stored at the first processor.

### EXAMPLE 5

A tangible, non-transitory, computer-readable medium is described herein. The computer readable medium comprises code to direct a processor to add a bearer in response to a bearer event (208) and detect a type of bearer and a corresponding Quality of Service parameter. The computer readable medium also comprises code to direct a processor to calculate an inactivity timeout value based on the type of bearer and a corresponding Quality of Service parameter.

In examples, the Quality of Service parameter may be a QCI or Traffic Class value. The Quality of Service parameter may be determined by analyzing a type of traffic by intercepting a Type of Service (TOS) bits of an IP traffic. Adding a bearer may comprise generating a new bearer entry or updating an existing bearer entry. Additionally, the inactivity timeout value may be calculated as the highest timeout value associated with each active bearer. The bearer may transmit data between an application processor and a remote device through a modem processor. Further, the inactivity timeout value may be calculated by an IPC master processor. In examples, the Quality of Service parameter may be stored at the modem processor. Also, the inactivity timeout value may be updated on the fly, according to any change of the Quality of service requirements reflected in the QCI or Traffic Class of the PDP context. The inactivity timeout value may also be updated on the fly, if a bearer may be put on hold or resumed.

### EXAMPLE 6

An apparatus for management of inactivity timer is described herein. The apparatus comprises processor and an inactivity timer control module, wherein the activity module is to retrieve a QoS parameter and compute an inactivity timeout value based on the QoS parameter.

In examples, the inactivity timer control module may send the inactivity timeout value to a device, and in response to receiving the inactivity timeout value, the inactivity timeout value at the device may be updated. The inactivity timer control module may monitor traffic on an IPC link. Additionally, inactivity timer control module may monitor traffic on an IPC link and intercept a new QoS parameter. The Quality of Service parameter may be a tabulated value that may be to reflect a traffic class of data. The Quality of Service parameter may also be a Quality of Service Class Identifier (QCI) for data traffic transmitted using fourth generation (4G) data transmission. Further, the Quality of Service parameter may be a traffic class of a packet data protocol (PDP) context for data traffic flowing over third generation (3G) data transmission. The Quality of Service parameter can also may be determined by analyzing a type of traffic by intercepting Type of Service (TOS) bits of data traffic. In examples, the Quality of Service parameter may be a combination of the Traffic Class of the Packet Data Protocol (PDP) context for the traffic flowing over 3G, or Quality of Service Class Identifier (QCI) for the traffic flowing over 4G, and the Type of Service bits for internet protocol (IP) traffic.

The inactivity timeout value may control a state of an IPC link. The state may be powered-down state or powered-up state. The state may be a sleep state or active state. The processor may be a modem processor or an application processor. In examples, a QCI or Traffic class value table may be stored at the processor.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present techniques.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the present techniques may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present techniques. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the present techniques as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus for management of inactivity timer, comprising:
a first processor;
a second processor communicatively coupled to the first processor via an inter-processor communication (IPC) link; and
an inactivity timer control module, wherein the inactivity timer control module is to manage a state of the IPC communication link via an inactivity timeout value based on a Quality of Service parameter.

2. The apparatus of claim 1, wherein the Quality of Service parameter is a tabulated value that is to reflect a traffic class of data.

3. The apparatus of claim 1, wherein the Quality of Service parameter is a Quality of Service Class Identifier (QCI) for data traffic transmitted using fourth generation (4G) data transmission.

4. The apparatus of claim 1, wherein the Quality of Service parameter is a traffic class of a packet data protocol (PDP) context for data traffic flowing over third generation (3G) data transmission.

5. The apparatus of claim 1, wherein the Quality of Service parameter is to be determined by analyzing a type of traffic by intercepting Type of Service (TOS) bits of data traffic.

6. The apparatus of claim 1, wherein the Quality of Service parameter is a combination of the Traffic Class of the Packet Data Protocol (PDP) context for the traffic flowing over 3G, or Quality of Service Class Identifier (QCI) for the traffic flowing over 4G, and the Type of Service bits for internet protocol (IP) traffic.

7. The apparatus of claim 1, wherein a state of the communications link is a power state.

8. The apparatus of claim 1, wherein the state is based on an inactivity timeout value to be calculated using QoS parameters from all traffic on the IPC link.

9. The apparatus of claim 1, wherein the inactivity timeout value is used by a driver to manage the IPC link.

10. The apparatus of claim 1, wherein the first processor is a modem processor, and the second processor is an application processor.

11. The apparatus of claim 1, wherein a QCI or Traffic class value table is to be stored at the first processor.

12. A method for dynamic management of an inactivity timer, comprising:
adding a bearer in response to a bearer event;
detecting a type of bearer and a corresponding Quality of Service parameter; and
calculating an inactivity timeout value based on the type of bearer and a corresponding Quality of Service parameter.

13. The method of claim 12, wherein the Quality of Service parameter is a QCI or Traffic Class value.

14. The method of claim 12, wherein the Quality of Service parameter is determined by analyzing a type of traffic by intercepting a Type of Service (TOS) bits of an internet protocol (IP) traffic.

15. The method of claim 12, wherein adding a bearer comprises generating a new bearer entry or updating an existing bearer entry.

16. The method of claim 12, wherein the inactivity timeout value is calculated as the highest timeout value associated with each active bearer.

17. The method of claim 12, the bearer transmits data between an application processor and a remote device through a modem processor.

18. A system for management of inactivity timer, comprising:
an inter-processor communication (IPC) link;
a memory that is to store instructions and that is communicatively coupled with the IPC link;
a inactivity timer control module;
a processor communicatively coupled to the memory, wherein when the processor is to execute the instructions, the processor is to:
communicate with an another processor via the IPC link, wherein the inactivity timer control module is to manage a state of the IPC link based on a Quality of Service parameter.

19. The system of claim 18, wherein the Quality of Service parameter is a tabulated value that is to reflect a traffic class of data.

20. The system of claim 18, wherein the Quality of Service parameter is a Quality of Service Class Identifier (QCI) for data traffic transmitted using 4G.

21. The system of claim 18, wherein the Quality of Service parameter is a traffic class of a packet data protocol (PDP) context for data traffic flowing over 3G.

22. An apparatus for management of inactivity timer, comprising:
a first processor;
an inactivity timer control module, wherein the inactivity timer control module is to retrieve a QoS parameter and compute an inactivity timeout value based on the QoS parameter.

23. The apparatus of claim 22, wherein the inactivity timer control module is to send the inactivity timeout value to a device.

24. The apparatus of claim 22, wherein the inactivity timer control module is to monitor traffic on an IPC link.

25. The apparatus of claim 22, wherein the inactivity timer control module is to monitor traffic on an IPC link and intercept a new QoS parameter.
